(19) United States
(12) Patent Application Publication
(10) Pub. No.: US 2014/0379514 A1
(43) Pub. Date: Dec. 25, 2014

(54) Name-Related Image Generation and Product

(71) Applicant: K Olesen Enterprises, LLC, St. Augustine, FL (US)

(72) Inventor: Kathy Olesen, St. Augustine, FL (US)

(73) Assignee: K OLESEN ENTERPRISES, LLC, St. Augustine, FL (US)

(21) Appl. No.: 13/923,039

(22) Filed: Jun. 20, 2013

(51) Int. Cl. G06Q 30/06

(52) U.S. Cl. CPC G06Q 30/0621
USPC 705/26.5

(57) ABSTRACT

Systems, methods and computer program products are disclosed that facilitate the selection and creation of a personalized gift which will be appreciated by the intended gift recipient. The personalized gift is based on the gift giver's knowledge of the gift recipient, including superficial knowledge, such as the gift recipient's first name. In an aspect, the personalized gift is a collage comprising one or more images from locales related to the gift recipient's name. Locale and the gift recipient names may be related by possessing identical names, shortened versions of the same name, similarly-spelled names, and the like.

### FIELD OF THE DISCLOSURE

The present disclosure generally relates to gift giving and more particularly to systems, methods and computer program products for facilitating selection of personalized gifts for a gift recipient where a gift giver does not possess significant intimate knowledge about the gift recipient.

### BACKGROUND

The statements in this section merely provide background information related to the present disclosure and may not constitute prior art.

Gift selection is difficult in many settings, particularly where the intended recipient of the gift is a casual acquaintance. The gift giver often feels pressure to give a gift which indicates a personal connection or will be meaningful for the gift recipient. If the gift giver is able to present the gift recipient with a meaningful gift, the gift giver may maintain or build relations with the gift recipient. Conversely, a misstep in gift giving may damage the relationship between gift giver and recipient.

Gifts are often given based on personal details, intimate knowledge, shared experiences, or common interests. Where the gift recipient is a casual acquaintance, such as a supervisor, the gift giver may only know the gift recipient's name and other tangential facts, such as restaurants where the recipient has eaten previously. Choosing a gift card as a gift may be given based on known interests, such as interest in a particular restaurant, but this may also be viewed poorly, especially where the gift card is given to a large, generic restaurant chain.

Generally, giving money or gift cards is often viewed as an indication of thoughtlessness, laziness, or an indicator of distance between the gift giver and the gift recipient. Many gift recipients view receiving money or gift cards negatively because it shifts the gift choosing process onto the gift receiver and, in the case of receiving a gift card, narrows that process to a merchant the gift recipient may or may not care to patronize. Finally, giving money or gift cards may appear miserly because, unlike a handmade gift or a carefully chosen item, the gift recipient is able to see precisely how much the gift giver was willing to spend.

Gift giving can also be difficult based on the circumstances of the gift exchange. The gift must be appropriate for the setting in which it is given. For example, in a professional gift exchange setting, it may be inappropriate to give someone a relationship building guide, even where such a gift would be welcomed in a more casual setting. Similarly, at a bridal shower, it would be inappropriate to present the bride-to-be with a crash dieting book.

Gift selection is also difficult where the gift giver and the gift recipient are from different cultures. For example, in America, flowers may be considered a romantic gift, representing love and desire. Giving a floral bouquet containing white chrysanthemums to a Chinese romantic interest is likely to end poorly, however, because white chrysanthemums are often used in Chinese funerals and symbolize death.

Gifts are generally considered to be thoughtful if they are connected to the gift recipient in a specific or personal way. For example, receiving something the gift recipient mentioned they wanted would be considered thoughtful. Presenting the gift recipient with something that enriches or simplifies the recipient's life would also be considered thoughtful because of the gift's specific, personal application. Additionally, gifts are appreciated when they relate to personal details of the recipient, even where those details are superficial (e.g., the gift recipient's zodiac sign, name, or birthplace).

Given the foregoing, systems, methods, and computer program products are needed that facilitate selection and creation of a personalized gift which will be appreciated by the intended gift recipient based on the gift giver's knowledge of the gift recipient. In particular, creation of a personalized gift which will be viewed as thoughtful by the gift recipient, even where the gift giver possesses mere superficial knowledge of the gift recipient (e.g. name, hometown, and the like), is needed.

Additionally, personalized gift devices are needed which are aesthetically pleasing and relevant to a gift recipient.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Aspects of the present disclosure meet the above-identified needs by providing systems, methods, and computer program products which facilitate selection and creation of a personalized gift which will be appreciated by the intended gift recipient based on the gift giver's knowledge of the gift recipient. Specifically, in an aspect, systems, methods, and computer program products are disclosed wherein a personalized gift is created. The personalized gift is designed based on information about the gift recipient and is intended to be viewed as thoughtful, even when the gift giver possesses mere superficial knowledge of the gift recipient. Superficial knowledge may be information casual acquaintances or co-workers know about one another, such as a name.

In an aspect, a personalized gift is created which is aesthetically pleasing and relevant to a gift recipient. The personalized gift is a collage comprising one or more images from locales related to the gift recipient's name.

In an aspect, locale and the gift recipient names may be related by possessing identical names, shortened versions of the same name, similarly spelled names, and the like. A locale and the gift recipient name may also be related by similarity in nickname, abbreviation, or other identifier.

The locale of a given image may be a city, street, borough, state, neighborhood, or other official or unofficial geographic classification. Each specific image included in the personalized gift may depict an arbitrary location, a well-known location, a location that has particular meaning to the gift recipient, a sign indicating the name of the locale, or the like. For example, where the locale is Gary, Ind., an arbitrary location may be a suburban street. A well-known location may be Gary City Hall. A location having particular meaning to the gift recipient may be a street in Gary, Ind. where the gift recipient grew up. A sign indicating the name of the locale may be a sign on the edge of Gary, Ind. stating “Welcome to Gary.”

The personalized gift described above may include additional elements, including, but not limited to: a map indicating all of the geographic locations of the locales pictured; and the gift recipient's name.

In an aspect, a user (i.e., the gift giver) utilizes a computer or mobile device to provide gift recipient data indicating the personal information of a gift recipient. Gift recipient data may include the gift recipient's first name. Systems, methods, and computer program products in accordance with the present disclosure include a database of images which have been previously categorized based on the geographic location of the image subject depicted in the stored image. Based on geographic content, images are identified which relate to the gift recipient data received from the user. These identified images are then presented to the user via, for example, a web browser. The user selects one or more of the images presented and optionally arranges them in an aesthetically pleasing collage. The finalized product is then created, comprising each of the selected images in the arrangement created by the user (if specified). The final product may be a two-dimensional print, a digital print, or another physical or digital object.

Personalized gifts as disclosed above enable a gift giver to create a thoughtful, one-of-a-kind, personalized gift for an individual based solely on the gift recipient's name. Such a gift is appropriate in both professional and casual settings. Gifts in accordance with the present disclosure are unlikely to offend the gift recipient based on cultural differences because an individual's name is widely used in a variety of instances.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of an exemplary system for facilitating the creation of a personalized gift, according to an aspect of the present disclosure.

FIGS. 2A-C are images of personalized gifts comprising gift-specific images and various additional elements, according to various aspects of the present disclosure.

FIG. 3 is a flowchart illustrating an exemplary process for facilitating the creation of a personalized gift, according to an aspect of the present disclosure.

FIG. 4 is a flowchart illustrating an exemplary process for facilitating user selection of elements comprising a personalized gift, according to an aspect of the present disclosure.

FIG. 5 is a flowchart illustrating an exemplary process for facilitating storage and categorization of images, according to an aspect of the present disclosure.

FIG. 6 is a flowchart illustrating an exemplary process for facilitating the creation of a personalized gift comprising a personal image, according to an aspect of the present disclosure.

FIG. 7 is a block diagram of an exemplary computing system useful for implementing aspects of the present disclosure.

### DETAILED DESCRIPTION

The present disclosure is directed to systems, methods, and computer program products that facilitate selection and creation of a personalized gift which will be appreciated by the intended gift recipient based on the gift giver's knowledge of the gift recipient.

Aspects of the present disclosure provide systems, methods, and computer program products wherein a personalized gift is created. The personalized gift is created based on information about the gift recipient and is intended to be viewed as thoughtful, even where the gift giver possesses mere surface knowledge of the gift recipient. Surface knowledge may be information casual acquaintances or co-workers know about one another, such as a name.

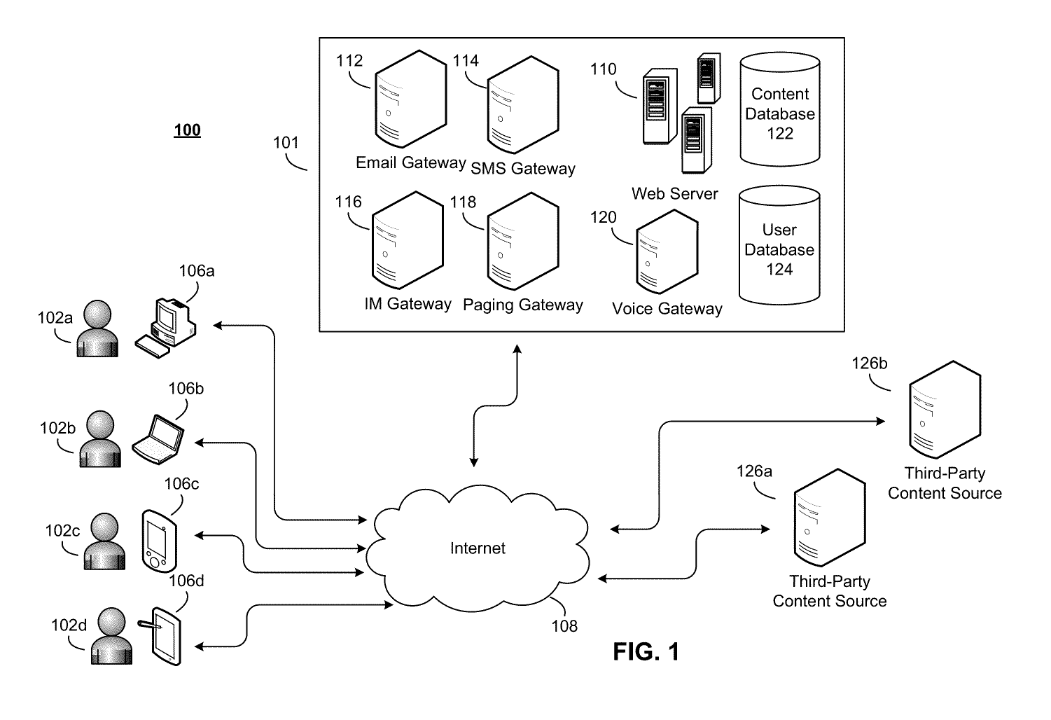

Referring now to FIG. 1, a block diagram of an exemplary system 100 for facilitating the creation of a personalized gift, according to an aspect of the present disclosure, is shown.

Cloud-based, Internet-enabled device communication system 100 includes a plurality of users 102 (shown as users 102a-d in FIG. 1) accessing—via a computing device 106 (shown as respective computing devices 106a-h in FIG. 1) and a network 108, such as the global, public Internet—an application service provider's cloud-based, Internet-enabled infrastructure 101. User 102 may access infrastructure 101 in order to facilitate creation of a personalized gift utilizing images stored within content database 122, third-party content source 126 (shown as third-part content source 126a-b in FIG. 1), or supplied by user 102. Computing device 106 may be a mobile device or it may be a kiosk comprising computing functionality.

In various aspects, computing device 106 may be configured as: a desktop computer 106a; a laptop computer 106b; a Personal Digital Assistant (PDA) or mobile telephone 106c; a tablet or mobile computer 106d; any commercially-available intelligent communications device; or the like. System 100 may further comprise printing devices such as inkjet, thermal, or laser printers (not shown in FIG. 1).

As shown in FIG. 1, in an aspect of the present disclosure, an application service provider's cloud-based, communications infrastructure 101 may include one or more web servers 110, an email gateway 112, an SMS gateway 114, an Instant Message (IM) gateway 116, a paging gateway 118, a voice gateway 120, content database 122, and a user database 124.

The term “image” and/or the plural form of this term are used throughout herein to refer to one or more images, renderings, text, or other visual information.

Content database 122 is configured to store images which may comprise personalized gifts created by systems, methods, and computer program products disclosed herein. Content database 122 may be configured to store data collected from third-party sources via Internet 108, such as third-party content source 126. Third-party content source 126 may be a free images source. In another aspect, third-party content source 126 may be a subscription-based or other paid source of images. For example, stock photo sources may be utilized, such as iStockphoto® (available from iStockphoto LP of Calgary, Canada) or Shutterstock® (available from Shutterstock, Inc. of New York, N.Y.). In another aspect, communications infrastructure 101 may communicate with third-party public image sources 126.

Content database 122 is further configured to store information related to the geographic content of each image stored in content database 122. In an aspect, content database 122 comprises an index of the geographic content of each image. Geographic content includes, but is not limited to, the location the image was taken, the location of the physical location of the content of the image (e.g., the location of a building shown in an image), names of geographic locales relevant to the image (e.g., the city where the image was taken), and shortened versions of the name of geographic locale relevant to the image, including similarly spelled names. A locale may be a city, town, parish, county, street, borough, state, neighborhood, or other official or unofficial geographic classification.

Images utilized in personal gifts may depict an arbitrary location, a well-known location, a location that has particular meaning to the gift recipient, a sign indicating the name of a location, and the like.

Content database 122 may store images or other content found via Internet 108. Content database 122 may be configured to store images or other content which have been modified, indexed, or annotated by other portions of system 100.

User database 124 may be physically separate from content database 122, logically separate, or physically or logically indistinguishable. User database 124 may be configured to store information about users 102 including previous personalized gifts created, account information, personal images, and the like. In an alternate aspect, user-provided images, personal images, and the like are stored in content database 122. In alternate aspects, user database 124 or content database 122 may comprise one or more data stores within (or remotely located from) infrastructure 101 or be a memory included in (or coupled to) web server 110.

As will be appreciated by those skilled in the relevant art(s) after reading the description herein, in such an aspect, an application service provider—an individual person, business, or other entity—may allow access, on a free registration, paid subscriber and/or pay-per-use basis, to infrastructure 101 via one or more World-Wide Web (WWW) sites on the Internet 108. Thus, system 100 is scalable.

As will also be appreciated by those skilled in the relevant art(s), in an aspect, various screens would be generated by server 110 in response to input from users 102 over Internet 108. That is, in such an aspect, server 110 is a typical web server running a server application at a website which sends out webpages in response to Hypertext Transfer Protocol (HTTP) or Hypertext Transfer Protocol Secured (HTTPS) requests from remote browsers on various computing devices 106 being used by various users 102. Thus, server 110 is able to provide a graphical user interface (GUI) to users 102 of system 100 in the form of webpages. These webpages are sent to the user's PC, laptop, mobile device, PDA or like device 106, and would result in the GUI being displayed.

As will be appreciated by those skilled in the relevant art(s) after reading the description herein, alternate aspects of the present disclosure may include providing a tool for facilitating the creation of personalized gifts to devices 106 as a stand-alone system (e.g., installed on one server PC) or as an enterprise system wherein all the components of infrastructure 100 are connected and communicate via an inter-corporate Wide Area Network (WAN) or Local Area Network (LAN). For example, in an aspect where users 102 are all personnel/employees of the same company, the present disclosure may be implemented as a stand-alone system, rather than as a web service (i.e., Application Service Provider (ASP) model utilized by various unassociated/unaffiliated users) as shown in FIG. 1.

As will also be appreciated by those skilled in the relevant art(s) after reading the description herein, alternate aspects of the present disclosure may include providing the tools for facilitating the creation of a personalized gift via infrastructure 101 and devices 106 via a browser pre-installed with an applet or a browser with a separately downloaded applet on such devices 106. That is, as will also be apparent to one skilled in the relevant art(s) after reading the description herein, the applet that facilitates the personalized gift platform disclosed herein, may be part of the “standard” browser that ships with computing device 106 or may be later added to an existing browser as part of an “add-on,” “plug-in,” or “app store download.”

The terms “user,” “individual”, and/or the plural form of these terms are used interchangeably throughout herein to refer to those persons or entities capable of accessing, using, being affected by and/or benefiting from the tool that the present disclosure provides.

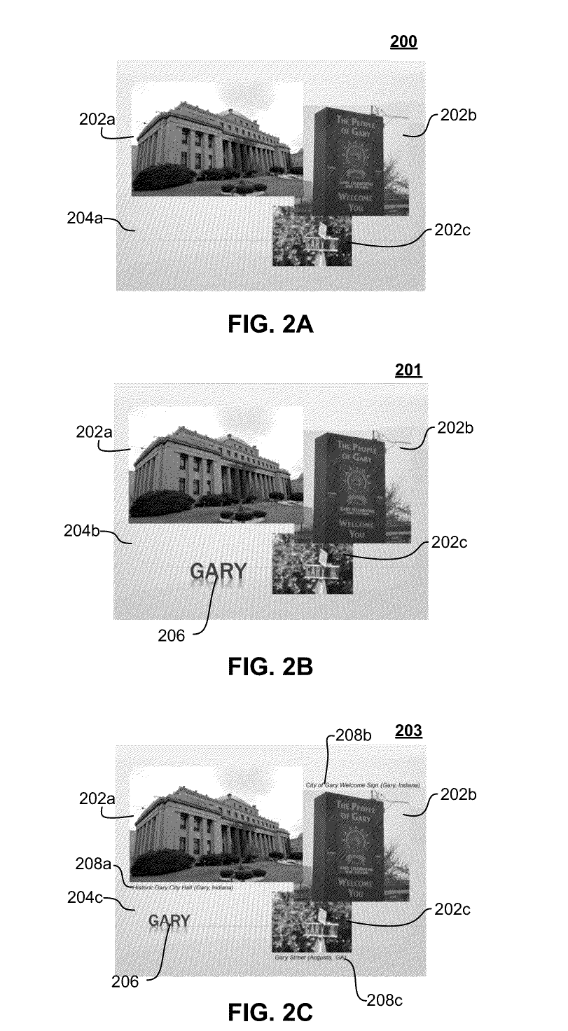

Referring now to FIGS. 2A-C, layouts 201, 203, 205 of personalized gifts 204 comprising gift-specific images 202 and various additional elements, according to various aspects of the present disclosure, are shown.

A personalized gift 204 (shown as personalized gift 204a-c in FIGS. 2A-C) may be a print comprising multiple gift-specific images 202 (shown as images 202a-c in FIGS. 2A-C). In another aspect, personalized gift may be a collage, an art print, a two-dimensional print, a digital print, or another physical or digital object comprising multiple images 202. Personalized gift 204 is created based on gift recipient data about a gift recipient provided by user 102. Images 202 are chosen to be relevant to the gift recipient via a relationship between the geographic content of image 202 and the gift recipient data. Gift recipient data may include the gift recipient's first name. In an aspect, gift recipient data may additionally include the gift recipient's middle name, last name, nickname, or other personal information, such as hometown, occupation, hobby, ancestry, and the like.

In an aspect, images 202 are related to the gift recipient's first name. For example, Layout 201 depicts personalized gift 204a designed for a gift recipient named Gary. Images 202a-c are related to the first name “Gary.” Image 202a depicts Gary City Hall in Gary, Ind. Image 202b depicts the welcome sign of Gary, Ind. Image 202c depicts a street sign for Gary Street in Augusta, Ga.

Image 202 may depict locations possessing a name identical to the gift recipient's name, shortened versions of their name, similarly spelled names, and the like. Image 202 may also be related to gift recipient data by similarity in nickname, abbreviation, or other identifiers. The location shown in image 202 may be a city, town, county, parish, street, borough, state, neighborhood, or other official or unofficial geographic classifications.

In another aspect, images 202 may depict locations which are related to other gift recipient data such as occupation, the gift recipient's hobbies, ancestry, or the like. For example, images 202 may depict a variety of historical post offices which is related to gift recipient data where the gift recipient is a post office worker.

Personalized gift 204 may comprise additional elements. Layout 203 depicts personalized gift 204b additionally comprising a gift recipient name 206. Name 206 may be all or a portion of the gift recipient data supplied by user 102. Depicting name 206 visually ties together image 202 and further personalizes personalized gift 204, thereby creating a more thoughtful gift. Name 206 may be any representation of all or a portion of gift recipient data which may be integrated into personalized gift 204 including, but not limited to, a digital image, a physical print, a picture, and the like.

In another aspect, layout 203 shows personalized gift 204c further comprising name and image information 208 (shown as image information 208a-c in FIG. 2C). Image information 208 may describe the content, geographic location, or other information relevant to an associated image 202. For example, image information 208a states “Historic Gary City Hall (Gary, Ind.)”. Image information 208a is associated with image 202a, a photograph of Gary City Hall in Gary, Ind.

In an aspect, image information 208 may comprise a map depicting the locations where each image 202 was taken.

As will be appreciated by those skilled in the relevant art(s) after reading the description herein, image information 208 may be provided by an application service provider, user 102 creating a gift for a gift recipient, a third-party source, third-party content source 126, and the like. In an aspect, user 102 provides image information 208 for one or more images or personal images included in personal gift 204. User-provided image information 208 may describe memories or experiences user 102 and gift recipient had that occurred at the location or relate to image 202. User-provided image information 208 may also comprise user 102 opinion on the content of image 202, such as expressing a desired to go to the location depicted.

Personalized gift 204 may comprise images 202 supplied by an application service provider, a third-party content source, or user 102 (not shown in FIGS. 2A-C). Images 202 supplied by user 102 may be referred to as “personal images” and may depict scenes relevant to the gift recipient, such as a picture of the gift recipient, a scene the gift recipient may find pleasing, and the like.

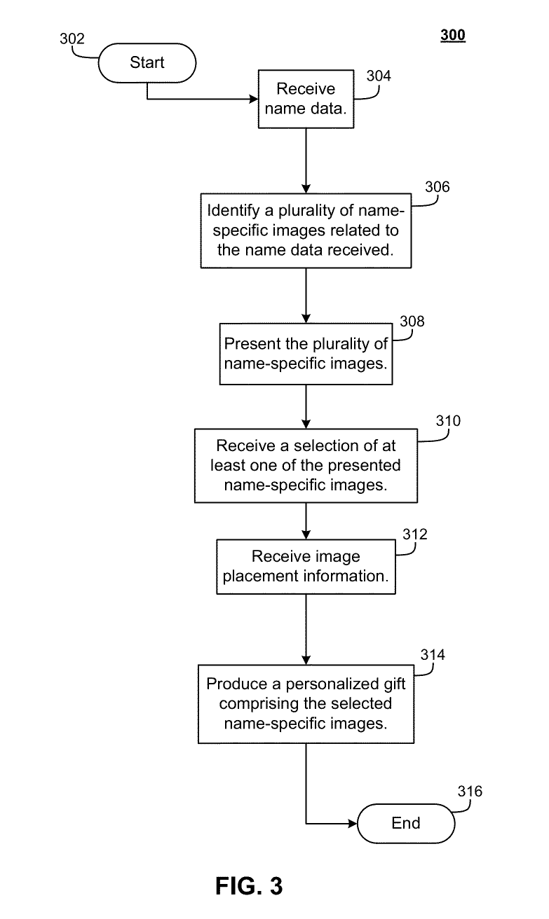

Referring now to FIG. 3, a flowchart illustrating an exemplary process 300 for facilitating the creation of personalized gift 204, according to an aspect of the present disclosure, is shown.

Process 300, which may execute within system 100 and facilitate creation of personalized gift 204, begins at step 302 with control passing immediately to step 304.

At step 304, infrastructure 101 receives gift recipient data from user 102. Gift recipient data may comprise a first name, middle name, last name, nickname, and the like of a gift recipient. For example, the first name “Gary” may be received in step 304 during process 300 which creates personalized gift 204a. Gift recipient data may be entered via a GUI displayed on computing device 106 and received at web server 110 via Internet 108.

At step 306, a plurality of images 202 within content database 122 are identified as related to the gift recipient data received in step 304. In an aspect, images 202 have been previously categorized based on the geographic content of the image subject depicted in image 202. Based on geographic content, images are identified as related to the gift recipient data received from user 102. In an aspect, relatedness is determined by comparing received gift recipient data with an index of geographic content of each image. Such an index may be stored in content database 122 and modified as additional images 202 are added to content database 122.

At step 308, images 202 identified in step 306 are presented to user 102. Images 202 may be presented via a GUI within computing device 106.

At step 310, infrastructure 101 receives a selection of images 202 presented to user 102 in step 308. The selection of images 202 are images 202 which user 102 has indicated should comprise personalized gift 204.

At step 312, infrastructure 101 receives placement information for images 202 selected by user 102. User 102 may provide placement information indicating the desired layout of images 202 comprising personalized gift 204. Placement information may be provided using a computer aided design tool built into a portion of system 100.

In an aspect, step 312 is omitted. Rather, infrastructure 101 arranges selected images 202 without receiving additional information from user 102. In another aspect, a second user 102, such as an employee of the application service provider, provides the placement information received in step 312.

At step 314, a finalized personalized gift 204 is created comprising images 202 selected in the arrangement specified by the received placement information, if such information has been provided. The finalized personalized gift 204 may be a two-dimensional print, a digital print, or another physical or digital object.

Process 300 then terminates at step 316.

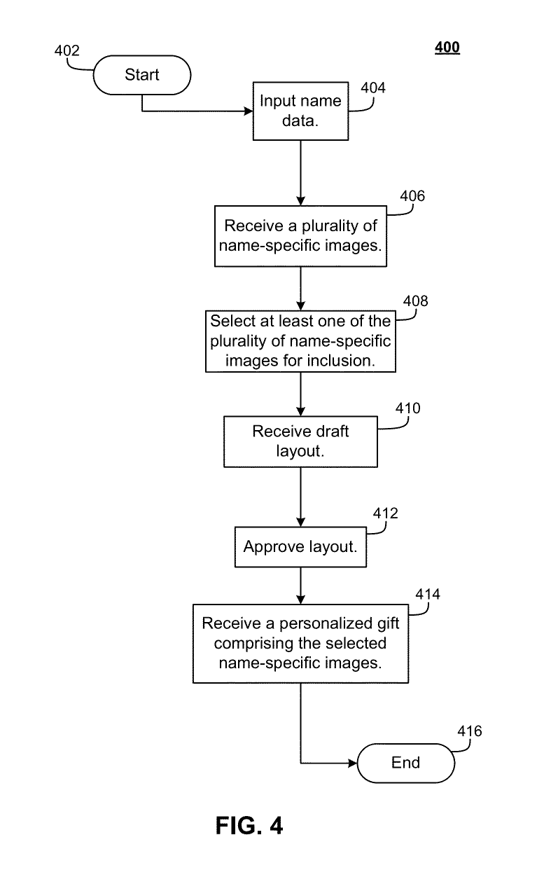

Referring now to FIG. 4, a flowchart illustrating an exemplary process 400 for facilitating user selection of elements comprising personalized gift 204, according to an aspect of the present disclosure, is shown.

Process 400, which may be carried out on portions of infrastructure 101 and facilitate user selection of elements comprising personalized gift 204, begins at step 402 with control immediately passing to step 404.

At step 404, user 102 provides infrastructure 101 with gift recipient data.

At step 406, user 102 is presented with a plurality of images 202 related to the gift recipient data user 102 provided in step 404.

At step 408, user 102 selects via, for example, computing device 106, at least one of the plurality of images 202 presented to user 102 in step 406.

In step 410, infrastructure 101 generates a layout depicting the image layout of personalized gift 204. User 102 is presented with the layout for visual inspection.

In step 412, the user 102 may approve the layout presented in step 410. In an aspect, if user 102 does not approve the layout, user 102 may provide placement information for images 202, select additional images, or otherwise modify the layout.

In another aspect, steps 410 and 412 are omitted. Rather, user 102 arranges the selected images 202.

In step 414, a finalized personalized gift 204 is created comprising images 202 selected in the arrangement specified in the received placement information, if such information has been provided. User 102 then receives personalized gift 204. The finalized personalized gift 204 may be a two-dimensional print, a digital print, or another physical or digital object. Where personalized gift 204 is a physical object, it may be shipped to the intended gift recipient, user 102, or another location.

Process 400 then terminates at step 416.

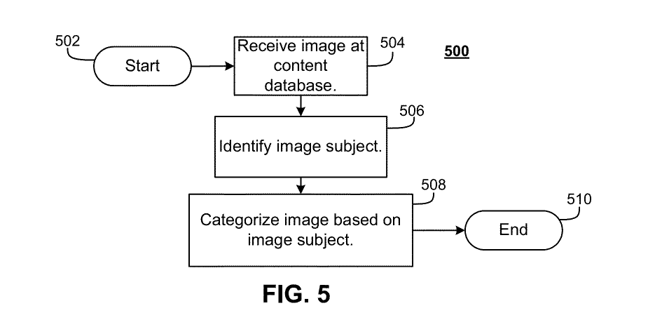

Referring now to FIG. 5, a flowchart illustrating an exemplary process 500 for facilitating storage and categorization of images 202, according to an aspect of the present disclosure, is shown.

Process 500, which may be carried out on portions of infrastructure 101 and facilitate storage and categorization of images 202, begins at step 502 with control immediately passing to step 504.

At step 504, one or more images 202 are received at content database 122. Images 202 may be received from third-party content sources 126, input by operators of infrastructure 101, or some other source.

At step 506, each image 202 examined in step 504 is categorized according to geographic content for later use. Such images 202 are stored in content database 122.

Process 500 then terminates at step 510.

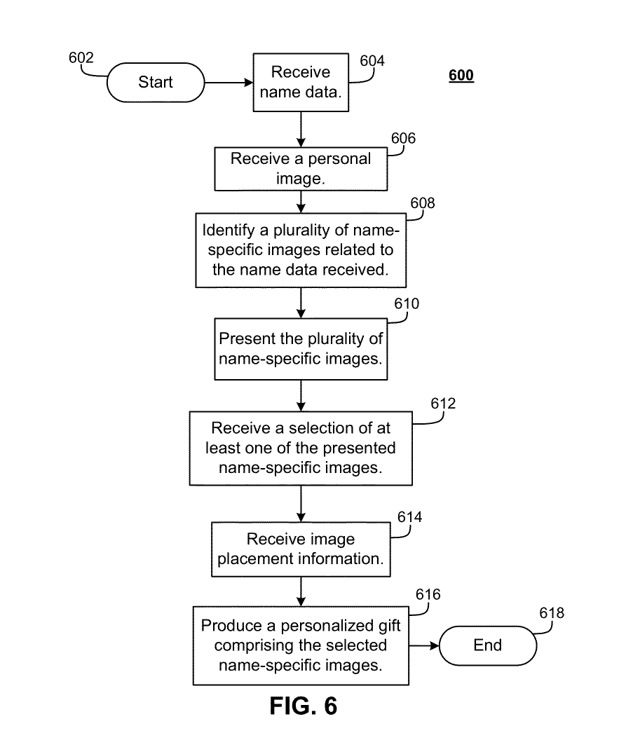

Referring now to FIG. 6, a flowchart illustrating an exemplary process 600 for facilitating the creation of personalized gift 204 comprising a personal image, according to an aspect of the present disclosure, is shown.

Process 600, which may be carried out on portions of system 100 and facilitate the creation of personalized gift 204 comprising at least one personal image, begins at step 602 with control immediately passing to step 604.

At step 604, infrastructure 101 receives gift recipient data from user 102.

At step 606, infrastructure 101 receives at least one personal image from user 102. The personal image provided is an image which user 102 wishes to integrate into personalized gift 204 created by process 600.

At step 608, a plurality of images 202 within content database 122 are identified as related to the gift recipient data received in step 604.

At step 610, images 202 identified in step 608 are presented to user 102. Images 202 may be presented via a GUI within computing device 106.

At step 612, infrastructure 101 receives a selection of images 202, presented to user 102 in step 610. The selection of images 202 are images 202 which user 102 has indicated should comprise personalized gift 204.

In another aspect, step 612 is omitted. User 102 does not select any images 202 that have been previously presented to user 102 and personalized gift 204 does not comprise images 202 identified by infrastructure 101. Rather personalized gift 204 comprises personal images.

At step 614, infrastructure 101 receives placement information for images 202 selected in step 612 and the personal image provided in step 606.

In an alternate aspect, step 614 is omitted. Rather, infrastructure 101 arranges selected images 202 and one or more personal images without receiving additional information from user 102. In another aspect, a second user 102, such as an employee of the application service provider, provides the placement information received in step 614.

At step 616, a finalized personalized gift 204 is created comprising images 202 selected and personal images provided in step 606. The personalized gift 204 may be in the arrangement specified by the received placement information, if such information has been provided.

Process 600 then terminates at step 618.

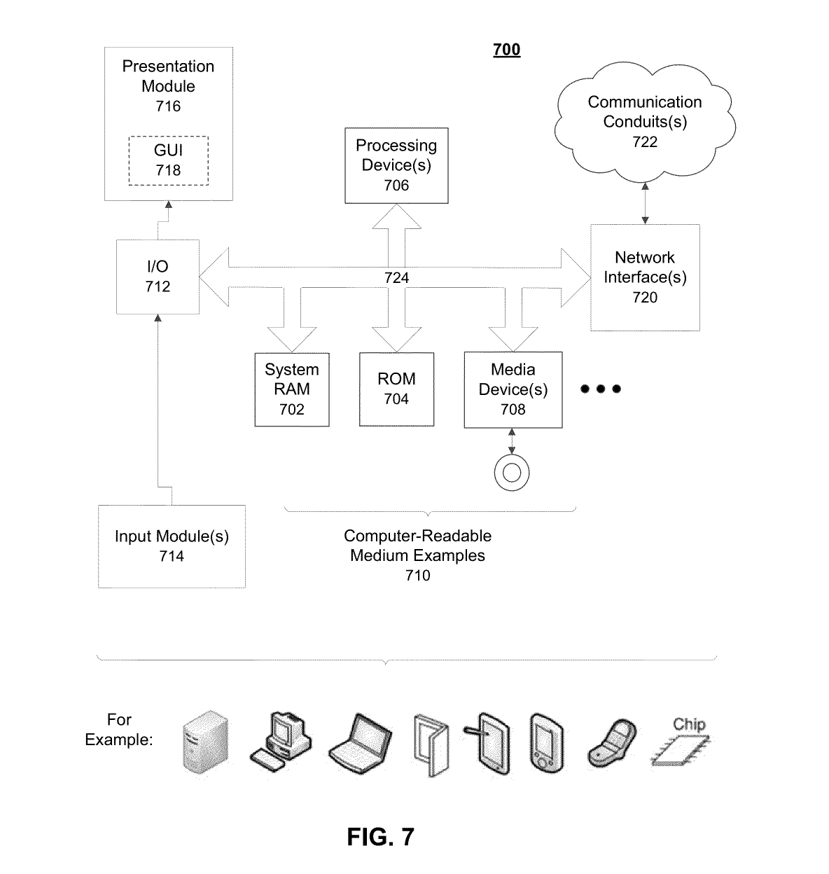

Referring now to FIG. 7, a block diagram of an exemplary computer system useful for implementing various aspects the processes disclosed herein, in accordance with one or more aspects of the present disclosure, is shown.

That is, FIG. 7 sets forth illustrative computing functionality 700 that may be used to implement web server 110, one or more gateways 112-120, content database 122, user database 124, third-party sources 126, computing devices 106 utilized by users 102 to access Internet 108, or any other component of system 100. In all cases, computing functionality 700 represents one or more physical and tangible processing mechanisms.

Computing functionality 700 may comprise volatile and non-volatile memory, such as RAM 702 and ROM 704, as well as one or more processing devices 706 (e.g., one or more central processing units (CPUs), one or more graphical processing units (GPUs), and the like). Computing functionality 700 also optionally comprises various media devices 708, such as a hard disk module, an optical disk module, and so forth. Computing functionality 700 may perform various operations identified above when the processing device(s) 706 execute(s) instructions that are maintained by memory (e.g., RAM 702, ROM 704, and the like).

More generally, instructions and other information may be stored on any computer readable medium 710, including, but not limited to, static memory storage devices, magnetic storage devices, and optical storage devices. The term “computer readable medium” also encompasses plural storage devices. In all cases, computer readable medium 710 represents some form of physical and tangible entity. By way of example, and not limitation, computer readable medium 710 may comprise “computer storage media” and “communications media.”

“Computer storage media” comprises volatile and non-volatile, removable and non-removable media implemented in any method or technology for storage of information, such as computer readable instructions, data structures, program modules, or other data. Computer storage media may be, for example, and not limitation, RAM 702, ROM 704, EEPROM, Flash memory, or other memory technology, CD-ROM, digital versatile disks (DVD), or other optical storage, magnetic cassettes, magnetic tape, magnetic disk storage, or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared, and other wireless media. Combinations of any of the above are also included within the scope of computer readable medium.

Computing functionality 700 may also comprise an input/output module 712 for receiving various inputs (via input modules 714), and for providing various outputs (via one or more output modules). One particular output module mechanism may be a presentation module 716 and an associated GUI 718. Computing functionality 700 may also include one or more network interfaces 720 for exchanging data with other devices via one or more communication conduits 722. In some embodiments, one or more communication buses 724 communicatively couple the above-described components together.

Communication conduit(s) 722 may be implemented in any manner (e.g., by a local area network, a wide area network (e.g., the Internet), and the like, or any combination thereof). Communication conduit(s) 722 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The terms “module” and “component” as used herein generally represent software, firmware, hardware, or combinations thereof. In the case of a software implementation, the module or component represents program code that performs specified tasks when executed on a processor. The program code may be stored in one or more computer readable memory devices. The features of the present disclosure described herein are platform-independent, meaning that the techniques can be implemented on a variety of commercial computing platforms having a variety of processors (e.g., set-top box, desktop, laptop, notebook, tablet computer, personal digital assistant (PDA), mobile telephone, smart telephone, gaming console, and the like).

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein). As will be appreciated by those skilled in the relevant art(s) after reading the description herein, certain features from different aspects of the systems, methods and computer program products of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A computer-implemented method for facilitating the creation of a personalized gift, the method comprising the steps of:
(a) receiving, from a user, gift recipient data indicating personal information of a gift recipient;
(b) identifying a plurality of gift-specific images stored on a content database, the plurality of gift-specific images being related to the gift recipient data received from the user;
(c) presenting the plurality of gift-specific images to the user;
(d) receiving, from the user, a selection of at least one of the plurality of gift-specific images; and
(e) producing a personalized gift for the gift recipient comprising the selection of at least one of the plurality of gift-specific images received from the user;
wherein each of the plurality of gift-specific images comprises an image subject, and the plurality of gift-specific images are categorized based on a geographic content of the image subject.

2. The method of claim 1, wherein gift recipient data comprises one of: a first name; a middle name; a last name; and a nick name.

3. The method of claim 1, further comprising the steps of:
(f) receiving, from the user, image placement information for the selection of at least one of the plurality of gift-specific images; and
(g) arranging the selection of at least one of the plurality of gift-specific images according to the image placement information received from the user.

4. The method of claim 1, further comprising the step of:
(h) receiving, from the user, a personal image;
wherein the personalized gift further comprises the personal image received from the user.

5. The method of claim 1, further comprising the step of:
(i) producing a name image of at least a portion of the gift recipient data received from the user;
wherein the gift recipient data received from the user comprises one of: a first name; a middle name; and a last name; and
wherein the personalized gift further comprises the name image.

6. The method of claim 1, wherein the personalized gift is a framed collage.

7. The method of claim 1, wherein the gift recipient data comprises a first name of the gift recipient; and
wherein a location name is associated with the geographic location of the image subject of each of the plurality of gift-specific images identified; and
wherein the location name and the first name are identical.

8. The method of claim 1, further comprising the step of:
(j) producing image information for at least one of the selection of at least one of the plurality of gift-specific images;
wherein the image information comprises image-related text; and
wherein the personalized gift further comprises the image information.

9. A system for facilitating the creation of a personalized gift, comprising:
(a) means for receiving, from a user, gift recipient data indicating personal information of a gift recipient;
(b) means for identifying a plurality of gift-specific images stored on a content database, the plurality of gift-specific images being related to the gift recipient data received from the user;
(c) means for presenting the plurality of gift-specific images to the user;
(d) means for receiving, from the user, a selection of at least one of the plurality of gift-specific images; and
(e) means for producing a personalized gift for the gift recipient comprising the selection of at least one of the plurality of gift-specific images received from the user;
wherein each of the plurality of gift-specific images comprises an image subject, and the plurality of gift-specific images are categorized based on a geographic content of the image subject.

10. The system of claim 9, further comprising:
(f) means for receiving, from the user, image placement information for the selection of at least one of the plurality of gift-specific images; and
(g) means for arranging the selection of at least one of the plurality of gift-specific images according to the image placement information received from the user.

11. The system of claim 9, further comprising:
(h) means for receiving, from the user, a personal image;
wherein the personalized gift further comprises the personal image received from the user.

12. The system of claim 9, further comprising:
(i) means for producing a name image of at least a portion of the gift recipient data received from the user;
wherein the gift recipient data received from the user comprises one of: a first name; a middle name; and a last name; and
wherein the personalized gift further comprises the name image.

13. The system of claim 9, wherein the gift recipient data comprises a first name of the gift recipient; and
wherein a location name is associated with the geographic location of the image subject of each of the plurality of gift-specific images identified; and
wherein the location name and the first name are identical.

14. The system of claim 9, further comprising:
(j) means for producing image information for at least one of the selection of at least one of the plurality of gift-specific images;
wherein the image information comprises image-related text; and
wherein the personalized gift further comprises the image information.

15. One or more computer storage media having stored thereon multiple instructions that facilitate the creation of a personalized gift by, when executed by one or more processors of a computing device, causing the one or more processors to:
(a) receive, from a user, gift recipient data indicating personal information of a gift recipient;
(b) identify a plurality of gift-specific images stored on a content database, the plurality of gift-specific images being related to the gift recipient data received from the user;
(c) present the plurality of gift-specific images to the user;
(d) receive, from the user, a selection of at least one of the plurality of gift-specific images; and
(e) produce a personalized gift for the gift recipient comprising the selection of at least one of the plurality of gift-specific images received from the user;
wherein each of the plurality of gift-specific images comprises an image subject, and the plurality of gift-specific images are categorized based on a geographic content of the image subject.

16. One or more computer storage media as recited in claim 15, wherein the multiple instructions further cause one or more processors to:
(f) receive, from the user, image placement information for the selection of at least one of the plurality of gift-specific images;
(g) arrange the selection of at least one of the plurality of gift-specific images according to the image placement information received from the user.

17. One or more computer storage media as recited in claim 15, wherein the multiple instructions further cause one or more processors to:
(h) receive, from the user, a personal image;
wherein the personalized gift further comprises the personal image received from the user.

18. One or more computer storage media as recited in claim 15, wherein the multiple instructions further cause one or more processors to:
(i) produce a name image of at least a portion of the gift recipient data received from the user;
wherein the gift recipient data received from the user comprises one of: a first name; a middle name; and a last name; and
wherein the personalized gift further comprises the name image.

19. One or more computer storage media as recited in claim 15, wherein the gift recipient data comprises a first name of the gift recipient; and
wherein a location name is associated with the geographic location of the image subject of each of the plurality of gift-specific images identified; and
wherein the location name and the first name are identical.

20. One or more computer storage media as recited in claim 15, wherein the multiple instructions further cause one or more processors to:
(j) produce image information for at least one of the selection of at least one of the plurality of gift-specific images;
wherein the image information comprises image-related text; and
wherein the personalized gift further comprises the image information.

21. A personalized gift device comprising:
a plurality of two-dimensional, gift-specific images selected by a user from a content database, the plurality of gift-specific images being related to gift recipient data indicating personal information of a gift recipient;
wherein each of the plurality of gift-specific images comprises an image subject located at an image subject geographic location;
wherein the gift recipient data comprises a first name of the gift recipient;
wherein a location name is associated with the image subject geographic location; and
wherein the location name and the first name are identical.

22. The personalized gift device of claim 21, wherein the personalized gift device is a framed collage.

23. The personalized gift device of claim 21, further comprising:
a two-dimensional name image of at least a portion of the gift recipient data;
wherein the gift recipient data comprises a first name.
